(19) United States
(12) Patent Application Publication
(10) Pub. No.: US 2026/0058864 A1
(43) Pub. Date: Feb. 26, 2026

(54) INTEGRATION OF SYSTEM ALERTS IN A COMMUNICATION NETWORK

(71) Applicants: DISH Network Technologies India Private Limited, Bangalore (IN); DISH Wireless L.L.C., Englewood, CO (US)

(72) Inventors: Amit Gupta, Faridabad (IN); Ajay Chahal, Piscataway, NJ (US)

(21) Appl. No.: 18/815,615

(22) Filed: Aug. 26, 2024

(51) Int. Cl. H04L 41/0659; H04L 41/0681; H04L 41/0686; H04L 41/0816

(52) U.S. Cl. CPC H04L 41/0661; H04L 41/0681; H04L 41/0686; H04L 41/0816

(57) ABSTRACT

An apparatus comprises a memory and a processor communicatively coupled to one another. The processor is configured to determine multiple integration parameters based on one or more configuration commands, collect performance data over a first period of time, structure the performance data based on the integration parameters, and generate a system alert in response to structuring the performance data. Further, the processor may be configured to determine whether the specific attribute parameter is at least partially different from at least one reference parameter in the reference alerts and transmit the system alert to a network coordination system interface configured to implement the change in the one or more communication operations in the communication network over the second period of time in response to determining that the specific attribute parameter is at least partially different from the at least one reference parameter in the reference alerts.

### TECHNICAL FIELD

The present disclosure relates generally to integration operations performed in a communication network, and more specifically to a system and method configured to perform integration of system alerts in the communication network.

### BACKGROUND

In a communication system, network resources enable multiple communication operations to be performed between multiple communication devices. Certain communication devices may use more network resources than others while performing same communication operations based on characteristics associated with each communication device. Further, these communication devices may be configured to perform specific communication operations based on a number of resources available at specific moments in time. For example, a communication device may be configured to perform a specific communication operation once over a period of time because a limited number of resources are available to the communication device over the period of time.

### SUMMARY OF THE DISCLOSURE

In one or more embodiments, a system and method disclosed herein are configured to integrate one or more system alerts in a communication network. The system alerts may be notifications and/or messages configured to trigger one or more changes in communication operations in the communication network. The system alerts may be updated periodically or dynamically over time. In one or more embodiments, the system may be configured to integrate system alerts into one or more communication triggers while ensuring that existing system alerts are not repeated. The system alerts may be generated based on unstructured data collected from performance data of one or more communication operations over a first period of time. The system may be configured to determine one or more integration parameters comprising instructions to structure the collected performance data. Herein, the system is configured to structure the performance data based on the integration parameters. The system may be configured to trigger changes to the communication operations over a second period of time. In some embodiments, the system is configured to generate new system alerts as a result of analyzing a structured version of the performance data. The system alerts may comprise one or more attribute parameters. As new system alerts are generated, individual attribute parameters may be compared to reference attribute parameters in existing system alerts (e.g., reference system alerts) to determine attributes that are currently considered for changes in the communication network. In some embodiments, new system alerts are inhibited from triggering changes based on attributes that are already considered by existing system alerts. For example, existing system alerts may be configured to trigger changes based on multiple parameters. One of the parameters may be a quality of a communication channel during a specific communication operation in a communication network. A new system alert may be generated based on existing needs in the communication network. Herein, the system may be configured to compare attribute parameters in the new system alert to one or more reference attribute parameters in one or more reference system alerts and determine whether the attribute parameters are found in the reference attribute parameters. If the attribute parameters are found in the reference attribute parameters, the system may be configured to determine that the new system alert is not needed in the communication system and discard the new system alert. If the attribute parameters are not found in the reference attribute parameters, the system may be configured to determine that the new system alert is needed in the communication system and transmit the system alert to a network coordination system interface configured to implement changes in the one or more communication operations over the second period of time.

In one or more embodiments, the systems and methods described herein are integrated into a practical application to evaluate new system alerts before publication in a communication network. In particular, the system and method are integrated into practical applications of: (1) maintaining a set of reference system alerts comprising one or more reference attribute parameters; (2) dynamically generating new system alerts comprising new attribute parameters based on current performance data collected from the communication network; (3) determining whether any of the new attribute parameters may be found in the reference attribute parameters; and (4) regulating, modifying, and/or controlling new system alerts and/or new attribute parameters that are performed in the communication network. The system and method may be configured to provide a deep understanding of system alerts implemented in the communication network. At a given point in time, the system and method may be configured to trigger update and/or replacement of any number of specific system alerts and/or specific attribute parameters based on analysis performed on collected performance data.

In addition, the systems and methods described herein are integrated into a technical advantage of increasing processing speeds in a computer system, because processors associated with the systems are configured to control creation of system alerts generated for use in the communication network. As network resources are used every time the communication network evaluates triggers for a specific system alert, processing resources are wasted for repeated system alerts. Herein, processing resources are saved because individual attribute parameters in the system alerts are evaluated to prevent repeated system alerts from consuming additional processing resources in the communication network. For example, an existing system alert may comprise existing attribute parameters that evaluate a condition A, a condition B, and a condition C. Following this example, the system and method may be configured to evaluate current performance data in the communication network and determine that future communication operations in the communication network comprise the condition C and a condition D. At this stage, the system and method may be configured to determine that any new system alerts to be published (e.g., implemented and/or released) in the communication network may not need to comprise new attribute parameters to evaluate the condition C because this condition is already evaluated in the existing system alert. The system may generate a new system alert that comprises a new attribute parameter to evaluate the condition D as this condition cannot be found as part of the existing attribute conditions. To this point, several processing resources may be saved and processing speeds may be greatly improved by dynamically inhibiting generation of repeated system alerts to evaluate conditions in one or more communication operations within communication networks servicing massive numbers (e.g., hundreds, thousands, or millions) of user devices over a period of time.

In one or more embodiments, the systems and methods may be performed by an apparatus, such as a server communicatively coupled to multiple network components in a core network, one or more base stations in a radio access network, and one or more user equipment. Further, the systems may be a wireless communication system, which comprises the apparatus. In addition, the systems may be performed as part of a process performed by the apparatus communicatively coupled to the network components in the core network. As a non-limiting example, the apparatus may comprise a memory and a processor communicatively coupled to one another. The memory may be operable to store one or more configuration commands configured to control one or more communication operations in a communication network and multiple reference alerts configured to trigger one or more changes to the one or more communication operations. Each reference alert may comprise at least one reference parameter configured to define at least one change to the one or more communication operations. The processor may be configured to determine multiple integration parameters based at least in part upon the one or more configuration commands. The integration parameters may be instructions to structure unstructured data collected from the one or more communication operations. Further, the processor may be configured to collect performance data over a first period of time, structure the performance data based at least in part upon the integration parameters, analyze a structured version of the performance data, and generate a system alert in response to analyzing the structured version of the performance data. The system alert may be configured to trigger a change to the one or more communication operations in the communication network over a second period of time. The system alert may comprise a specific attribute parameter. The processor may be configured to determine whether the specific attribute parameter is at least partially different from the at least one reference parameter in the reference alerts and transmit the system alert to a network coordination system interface configured to implement the change in the one or more communication operations in the communication network over the second period of time in response to determining that the specific attribute parameter is at least partially different from the at least one reference parameter in the reference alerts.

Certain embodiments of this disclosure may comprise some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure reference is now made to the following brief description taken in connection with the accompanying drawings and detailed description wherein like reference numerals represent like parts.

FIG. 1 illustrates an example communication system in accordance with one or more embodiments and

FIG. 2 illustrates an example flowchart of a method to perform one or more integration operations in accordance with one or more embodiments.

### EXAMPLE EMBODIMENTS

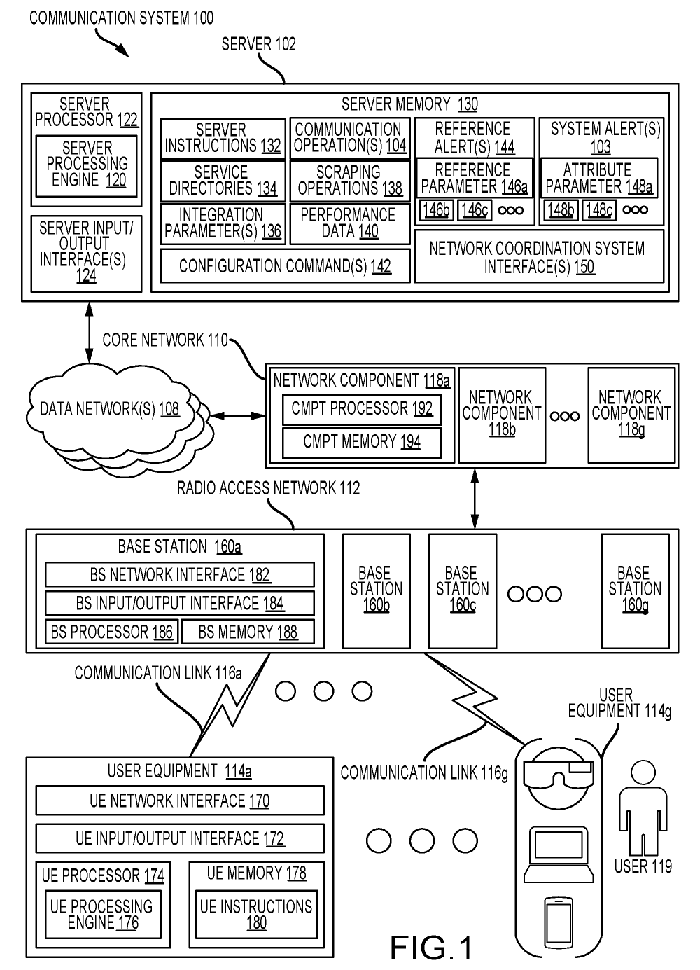

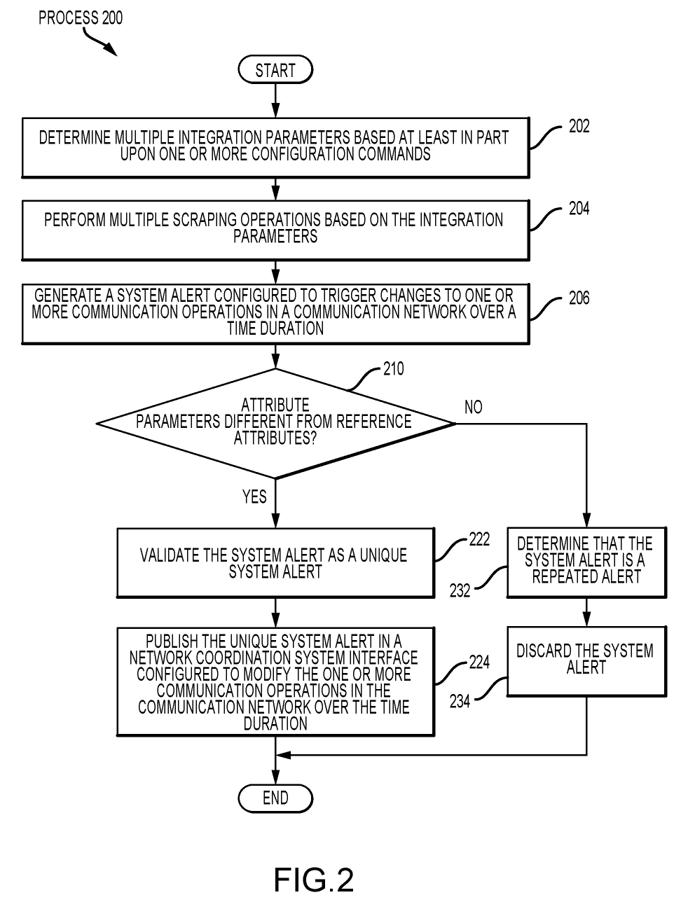

In one or more embodiments, systems and methods described herein are configured to perform one or more integration operations. In one or more embodiments, FIG. 1 illustrates a communication system 100 in which a server 102 is configured to integrate one or more system alerts 103 in one or more communication operations 104. FIG. 2 illustrates a process 200 to integrate the one or more system alerts 103 in the one or more communication operations 104.

### Communication System Overview

FIG. 1 illustrates a diagram of a communication system 100 eg a wireless communication system that comprises a server 102 configured to integrate one or more system alerts 103 in one or more communication operations 104 in accordance with one or more embodiments In the communication system 100 of FIG. 1 the server 102 may be the communication terminal communicatively coupled to one or more data networks 108 a core network 110 and a radio access network RAN 112 In FIG. 1 the server 102 is communicatively coupled to multiple user equipment 114a-114g collectively user equipment 114 via the RAN 112 via multiple corresponding communication links 116a-116g collectively communication links 116 established between each user equipment 114 and the RAN 112 As represented by a user equipment 114g the user equipment 114 may be operated or attended by one or more users 119 In the example of FIG. 1 the server 102 may be communicatively coupled to multiple additional devices in the communication system 100 While FIG. 1 shows the server 102 connected directly to the one or more data networks 108 the server 102 may be located inside the core network 110 as part of one or more of the network components eg any of the network components 118a-118g in the core network 110

In one or more embodiments the communication system 100 comprises the user equipment 114 the RAN 112 the core network 110 the one or more data networks 108 and the server 102 In come embodiments the communication system 100 may comprise a Fifth Generation 5G mobile network or wireless communication system utilizing high frequency bands eg 24 Gigahertz GHz 39 GHz and the like or lower frequency bands such eg Sub 6 GHz In this regard the communication system 100 may comprise a large number of antennas In some embodiments the communication system may perform one or more operations associated with the 5G New Radio NR protocols described in reference to the Third Generation Partnership Project 3GPP As part of the 5G NR protocols the communication system 100 may perform one or more millimeter mm wave technology operations to improve bandwidth or latency in wireless communications

In some embodiments, the communication system 100 may be configured to partially or completely enable communications via one or more various radio access technologies (RATs), wireless communication technologies, or telecommunication standards, such as Global System for Mobiles (GSM) (e.g., Second Generation (2G) mobile networks), Universal Mobile Telecommunications System (UMTS) (e.g., Third Generation (3G) mobile networks), Long Term Evolution (LTE) of mobile networks, LTE-Advanced (LTE-A) mobile networks, 5G NR mobile networks, or Sixth Generation (6G) mobile networks.

### Communication System Components

### Server

The server 102 is generally any device or apparatus that is configured to process data communicate with the data networks 108 one or more network components 118a-118g collectively network components 118 in the core network 110 the RAN 112 and the user equipment 114 The server 102 may be configured to monitor track data control routing of signal and control operations of certain electronic components in the communication system 100 associated databases associated systems and the like via one or more interfaces The server 102 is generally configured to oversee operations of a server processing engine 120 The operations of the server processing engine 120 are described further below In some embodiments the server 102 comprises a server processor 122 one or more server Input IOutput O interfaces 124 and a server memory 130 communicatively coupled to one another The server 102 may be configured as shown or in any other configuration As described above the server 102 may be located in one of the network components 118 located in the core network 110 and may be configured to perform one or more network functions NFs

The server processor 122 may comprise one or more processors operably coupled to and in signal communication with the one or more server IO interfaces 124 and the server memory 130 The server processor 122 is any electronic circuitry including but not limited to state machines one or more central processing unit CPU chips logic units cores eg a multi-core processor field-programmable gate arrays FPGAs application-specific integrated circuits ASICs or digital signal processors DSPs The server processor 122 may be a programmable logic device a microcontroller a microprocessor or any suitable combination of the preceding The one or more processors in the server processor 122 are configured to process data and may be implemented in hardware or software executed by hardware For example the server processor 122 may be an 8-bit a 16-bit a 32-bit a 64-bit or any other suitable architecture The server processor 122 may comprise an arithmetic logic unit ALU to perform arithmetic and logic operations processor registers that supply operands to the ALU and store the results of ALU operations and a control unit that fetches software instructions such as server instructions 132 from the server memory 130 and executes the server instructions 132 by directing the coordinated operations of the ALU registers and other components via the server processing engine 120 The server processor 122 may be configured to execute various instructions For example the server processor 122 may be configured to execute the server instructions 132 to perform functions or perform operations disclosed herein such as some or all of those described with respect to FIGS. 1 and 2 In some embodiments the functions described herein are implemented using logic units FPGAs ASICs DSPs or any other suitable hardware or electronic circuitry

In one or more embodiments, the server I/O interfaces 124 may be hardware configured to perform one or more communication operations 202-234 described in process 200 in reference to FIG. 2. The server I/O interfaces 124 may comprise one or more antennas as part of a transceiver, a receiver, or a transmitter for communicating using one or more wireless communication protocols or technologies. In some embodiments, the server I/O interfaces 124 may be configured to communicate using, for example, NR or LTE using at least some shared radio components. In other embodiments, the server I/O interfaces 124 may be configured to communicate using single or shared radio frequency (RF) bands. The RF bands may be coupled to a single antenna, or may be coupled to multiple antennas (e.g., for a multiple-input multiple output (MIMO) configuration) to perform wireless communications. The server I/O interfaces 124 may be configured to comprise one or more peripherals such as a network interface, one or more administrator interfaces, and one or more displays.

The server network interfaces that may be part of the server IO interfaces 124 may be any suitable hardware or software eg executed by hardware to facilitate any suitable type of communication in wireless or wired connections These connections may comprise but not be limited to all or a portion of network connections coupled to additional network components 118 in the core network 110 the RAN 112 the user equipment 114 the Internet an Intranet a private network a public network a peer-to-peer network the public switched telephone network a cellular network a local area network LAN a metropolitan area network MAN a wide area network WAN and a satellite network The server network interface may be configured to support any suitable type of communication protocol

The one or more administrator interfaces that may be part of the server I/O interfaces 124 may be user interfaces configured to provide access and control to of the server 102 to one or more users (e.g., the user 119) or electronic devices. The one or more users may access the server memory 130 upon confirming one or more access credentials to demonstrate that access or control to the server 102 may be modified. In some embodiments, the one or more administrator interfaces may be configured to provide hardware and software resources to the one or more users. Examples of user devices comprise, but are not limited to, a laptop, a computer, a smartphone, a tablet, a smart device, an Internet-of-Things (IoT) device, a simulated reality device, an augmented reality device, or any other suitable type of device. The administrator interfaces may enable access to one or more graphical user interfaces (GUIs) via an image generator display (e.g., one or more displays), a touchscreen, a touchpad, multiple keys, multiple buttons, a mouse, or any other suitable type of hardware that allow users to view data or to provide inputs into the server 102. The server 102 may be configured to allow users to send requests to one or more user equipment 114.

In the example of FIG. 1, the one or more displays that may be part of the server I/O interfaces 124 may be configured to display a two-dimensional (2D) or three-dimensional (3D) representation of a service. Examples of the representations may comprise, but are not limited to, a graphical or simulated representation of an application, diagram, tables, or any other suitable type of data information or representation. In some embodiments, the one or more displays may be configured to present visual information to one or more users (not shown). The one or more displays may be configured to present visual information to the one or more users updated in real-time. The one or more displays may be a wearable optical display (e.g., glasses or a head-mounted display (HMD)) configured to reflect projected images and enable user to see through the one or more displays. For example, the one or more displays may comprise display units, one or more lenses, one or more semi-transparent mirrors embedded in an eye glass structure, a visor structure, or a helmet structure. Examples of display units comprise, but are not limited to, a cathode ray tube (CRT) display, a liquid crystal display (LCD), a liquid crystal on silicon (LCOS) display, a light emitting diode (LED) display, an organic LED (OLED) display, an active-matrix OLED (AMOLED) display, a projector display, or any other suitable type of display. In another embodiment, the one or more displays are a graphical display on the server 102. For example, the graphical display may be a tablet display or a smartphone display configured to display the data representations.

The server memory 130 may be volatile or non-volatile and may comprise a read-only memory ROM random-access memory RAM ternary content-addressable memory TCAM dynamic random-access memory DRAM and static random-access memory SRAM The server memory 130 may be implemented using one or more disks tape drives solid-state drives and or the like The server memory 130 is operable to store the server instructions 132 one or more service directories 134 one or more integration parameters 136 the one or more communication operations 104 one or more scraping operations 138 one or more performance data one or more configuration commands 142 one or more reference alerts 144 eg reference system alerts comprising one or more reference parameters 146 eg one or more reference attribute parameters such as a reference parameter 146a a reference parameter 146b and a reference parameter 146c among others the one or more system alerts 103 eg newly-generated system alerts comprising one or more newly-generated attribute parameters 148 eg one or more dynamically-generated attribute parameters such as an attribute parameter 148a an attribute parameter 148b and an attribute parameter 148c among others and one or more network coordination system interfaces 150 among others In the server memory 130 the server instructions 132 may comprise commands and controls for operating one or more specific NFs in the core network 110 when executed by the server processing engine 120 of the server processor 122

In one or more embodiments the instructions 132 are configured to instruct one or more network components 118 in the core network 110 to establish one or more integration parameters 136 one or more communication operations 104 and or one or more scraping operations 138 The one or more configuration scripts may be configured to enable automation of routing and or configuration of network components 118 in the core network 110 In this regard the one or more configuration scripts may reconfigure multiple cloud-NFs CNFs that establish initial communication sessions with at least one network repository function NRF in a communication path comprising one or more additional network components 118 In this regard the one or more configuration scripts may be configured to instruct routing and or configuration of communication procedures based on static routing commands to restore services eg applications in the core network 110

The one or more service directories 134 may be configured to store service-specific information and or user-specific information The service directories 134 may enable the server 102 to confirm user credentials to access one or more network components eg one of the network components 118 configured to perform one or more NFs in the core network 110 The service directories 134 may be configured to store provider-specific information The service directories 134 may enable the server 102 to validate credentials associated with a specific provider eg one of the CNFs against corresponding user-specific information in the service directories 134 The service directories 134 may be configured to store one or more tenant profiles and a reference to one or more services The service directories 134 may be configured to store provider-specific information and service-specific information The provider-specific information may enable the server 102 to validate credentials associated with a specific provider eg one of the NFs against corresponding user-specific information and service-specific information

The one or more integration parameters 136 are configured to instruct the one or more user equipment 114 to establish one or more configuration commands 142 to perform one or more operations in the communication system 100 in a specific order The one or more integration parameters 136 may enable automation of the analysis of the communication operations 104 and or the scraping operations 138 The integration parameters 136 may be instructions to structure unstructured data collected from the one or more communication operations 104 and or the one or more scraping operations 138 Further the integration parameters 136 may indicate one or more changes to the one or more communication operations 104 and or the one or more scraping operations 138 In some embodiments the one or more integration parameters 136 may be predetermined and or dynamically assigned by a corresponding user equipment 114 or an organization associated with the server 102 In some embodiments the one or more integration parameters 136 may be one or more configuration parameters configured to provide guidelines and or information to inform the analyses performed by the server processor 122 The integration parameters 136 may be updated periodically over time The integration parameters 136 may be updated dynamically over time The integration parameters 136 may be guidelines to analyze current network resource availability information the communication operations 104 and or the performance data 140

The one or more communication operations 104 may be one some and or all signaling exchanged between the server 102 one or more network components 118 eg nodes and routers among others the one or more base stations 160 the one or more user equipment 114 and or any other equipment and or devices associated with the one or more data networks 108 The communication operations 104 may be any control commands and or signaling associated with transmissions and or receptions of one or more devices in the communication system 100 The one or more communication operations 104 may be one or more data exchanges performed between two or more network devices in the system 100 The network devices may comprise the server 102 the one or more network components 118 and or one or more of the user devices 106 among others In one or more embodiments the communication operations 104 may be audio communications exchanged as part of audio conversations eg during a telephonic call between two or more network devices The communication operations 104 may be image and or text communications exchanged as part of image-based conversations eg during videocalls and or chat exchanges between two or more network devices

In one or more embodiments the scraping operations 138 are one or more operations performed to inhibit reduce and or prevent loss and or waste of network resources in the communication system 100 by collecting performance data 140 from the one or more communication operations 104 over time Further the scraping operations 138 are one or more operations to identify and or collect processing consumption memory consumption and or power consumption in the performance data 140 The scraping operations 138 may be configured to collect unstructured data eg without a specific format and or unstructured data eg with a specific format The scraping operations 138 may be configured to scan categorize and or structure the performance data 140 over time

In one or more embodiments the one or more scraping operations 138 may be configured to evaluate one or more microservices eg applications and or services and determine one or more information parameters to collect as performance data 140 The scraping operations 138 may be performed by the server 102 and or another server configured to collect and or scrape metrics from one or more targets Herein the server 102 may be configured to collect metrics from one or more communication devices acting as endpoints of communication operations 104 The scraping operations 138 may be configured to retrieve performance data 140 between one or more time intervals The scraping operations 138 may track performance data 140 associated with the server 102 during the communication operations 104 In some embodiments the scraping operations 138 may comprise collecting unstructured data and structuring the unstructured data into corresponding structured versions The scraping operations 138 may be configured to retrieve performance data 140 associated with communication operations 104 performed by communication devices using and or comprising one or more virtual containers in one or more virtual environments eg Kubernetes and or wireless eg cloud communication environments and or networks The scraping operations 138 may be dynamically or periodically updated based on one or more integration parameters 136

The performance data 140 may be information comprising availability of one or more network resources used eg consumed to perform the one or more communication operations 104 In some embodiments the performance data 140 is dynamic information determined by the server 102 during a maintenance window In other embodiments the performance data 140 is dynamic information that is determined by the server 102 outside of a maintenance window In one or more embodiments the server 102 may receive and or collect the performance data 140 statically eg in a predefined period of time and or dynamically over time In some embodiments the performance data 140 may be updated in accordance with rules and policies of an organization The performance data 140 may comprise allocation information that informs creation of commands configured to modify usage of network resources in a wireless communication network The performance data 140 may comprise one or more conditions under which the communication operations 104 are performed corresponding to one or more communication devices one or more corresponding virtual containers and or one or more containerized environments

In one or more embodiments the one or more configuration commands 142 may be communications or messages configured to indicate requests for access of an application via an application programming interface API or a service The one or more configuration commands 142 may be communications and or messages requesting access to specific network resources in a network slice in accordance with a corresponding priority level Further the one or more configuration commands 142 may be requests for reallocation of one or more network resources to provide one or more connectivity allowances eg access between the server 102 the user equipment 114 the base stations 160 and one or more of the network components 118 The one or more configuration commands 142 may be requested for specific user devices eg departments and or tenants The one or more configuration commands 142 may be predefined or dynamically defined in accordance with one or more rules and policies and or the one or more integration parameters 136 The configuration commands 142 are configured to establish one or more communication sessions between two or more network components 118 in the core network 110 The configuration commands 142 may be configured to establish one or more communication sessions between one or more network components 118 in the core network 110 and one of the user equipment 114 Each configuration command of the configuration commands 142 may establish a communication session between a first network component of the network components 118 comprising the server 102 and a second network component of the network components 118 based at least in part upon a first configuration command of the configuration commands 142 The configuration commands 142 may be routing and configuration information for reinstating or reestablishing communication sessions when a change is detected in the operations of the core network 110 For example in response to losing a specific communication session established with the first access command the server 102 may attempt to reinstate the specific communication session based at least in part upon a second access command The configuration commands 142 may be dynamically or periodically updated from another of the network components 118 in the core network 110 Herein communication sessions refer to communication signals exchanged between the server 102 and additional network components 118 in the core network 110 In some embodiments the configuration commands 142 are provided to the server 102 from another of the network components 118 performing a specific NF The configuration commands 142 may be configured to enable access of the one or more services The configuration commands 142 may be configured to enable access of one or more name-spaces not shown and or one or more slice groups not shown in a given containerized cluster

The reference alerts 144 may comprise one or more indicators that trigger one or more changes in the communication network. The reference alerts 144 may be reference data configured to be retrieved and references by the server 102 over time. The reference alerts 144 may be multiple previous system alerts 103 that were generated by the server 102. The reference alerts 144 may be currently used to generate notifications, alarms, and/or warnings in the communication network. Each of the reference alerts 144 may comprise one or more reference parameters 146. The reference parameters 146 may be reference data configured to be retrieved and references by the server 102 over time. The reference parameters 146 may be previous attribute parameters 148 that were generated by the server 102. The reference parameters 146 may be currently used to evaluate one or more conditions in the communication operations 104.

The reference parameters 146 and/or the attribute parameters 148 may be flags representative of one or more conditions in network resource utilization of the communication system 100. The reference parameters 146 and/or the attribute parameters 148 may be representative of conditions (e.g., communication conditions such as quality, power consumption, specific configuration of network resources, and/or specific numbers of NFs in the communication network among others). The network resource utilization may comprise information relating to one or more network resources used in the communication system 100. The network resources may be power resources, memory resources, and/or processing resources that are consumed in the communication system 100 to communicate in one or more data networks 108 using a communication spectrum. The network resources may be power resources and/or frequency resources in the communication spectrum used as a basis to perform one or more communication operations in one or more communication sites. The one or more conditions may be one or more configuration parameters configured to provide guidelines and/or information to inform the analyses performed by the server processor 122. The conditions may be different or the same for different communication operations 104. The conditions may be different or the same for same communication operations 104 performed at different periods of time. The reference parameters 146 and/or the attribute parameters 148 may comprise information representative of network resource utilization and/or one or more resource demands in the communication network. In one or more embodiments, the reference parameters 146 and/or the attribute parameters 148 may comprise thresholds. The thresholds may be one or more specific numbers and/or number ranges associated with a specific parameter and/or indicator. The thresholds may be a specific value representing a higher boundary or a lower boundary. The thresholds may be one or more threshold ranges comprising higher boundaries and lower boundaries. The thresholds may be a percentage value representing a similarity and/or a difference between the network resource utilization requested in resource demands and a current network resource utilization. The thresholds may be determined based on information associated with the communication operations 104. The thresholds may be determined dynamically over time. The thresholds may be predefined and/or predetermined in accordance with information in activity associated with one or more of the communication operations 104. In some embodiments, the server 102 may be configured to calculate the thresholds based on information obtained via the server I/O interfaces 124 and/or UE network interfaces 170.

The one or more reference alerts and the one or more system alerts 103 may be one or more triggering commands configured to inform the server 102 on whether the one or more reference parameters 146 and/or the one or more attribute parameters 148 are met within a predefined time duration. The one or more reference parameters 146 and/or the one or more attribute parameters 148 may be configured to cause one or more triggers generated by the server 102. In some embodiments, the one or more reference alerts 144 and/or the one or more system alerts 103 may be predefined and/or dynamically generated over time. The one or more reference alerts 144 and/or the one or more system alerts 103 may be generated by the server 102 and/or one or more of the network components 118.

The one or more network coordination system interfaces 150 may be a system configured to collect real-time performance data 140 from network elements, such as the network components 118 (e.g., comprising switches, routers, and/or access points), the base stations 160, and/or the user equipment 114. The performance data 140 is used to provide insights into the health of the communication network. In one or more embodiments, the network coordination system interface 150 may be a network management system (NMS) as defined in the technical specifications of the 3GPP standards. The network coordination interfaces may be configured to implement one or more changes in the one or more communication operations 104 in the communication network over the one or more periods of time. The network coordination system interface 150 may be configured to be triggered by the server 102 to publish, present, and/or provide to the network newly generated system alerts 103. In some embodiments, the network coordination system interface 150 may be configured to receive new system alerts 103, determine the specific attribute parameters 148 in each of the new system alerts 103, publish (e.g., broadcast and/or present) the new system alerts 103 to the rest of the communication network, cause the new system alerts 103 to be stored as reference alerts 144 for subsequent analysis operations, and cause the specific attribute parameters 148 to be stored as reference parameters 146 for subsequent analysis operations.

### User Equipment

In one or more embodiments, each of the user equipment 114 (e.g, the user equipment 114a and a user equipment 114g representative of the user equipment 114a-114g) ma be any computing device configured to communicate with others devices, such as the server 102, other network components 118 in the core network 110, databases, and the like in the communication system 100. Each of the user equipment 114 may be configured to perform specific functions described here and interact with one or more network components 118 in the core network 110 via one or more base stations 160. Examples of user equipment 114 comprise, but are not limited to, a laptop, a computer, a smartphone, a tablet, a smart device, an IoT device, a simulated reality device, an augmented reality device, or any other type of device.

In one or more embodiments referring to the user equipment 114a as a non-limiting example of the user equipment 114 the user equipment 114a may comprise a user equipment UE network interface 170 a UE IO interface 172,a UE processor 174 configured to execute a UE processing engine 176 and a UE memory 178 comprising one or more UE instructions 180 The UE network interface 170 may be any suitable hardware or software eg executed by hardware to facilitate any suitable type of communication in wireless or wired connections These connections may comprise but not be limited to all or a portion of network connections coupled to additional network components 118 in the core network 110 the RAN 112 the Internet an Intranet a private network a public network a peer-to-peer network the public switched telephone network a cellular network a local area network LAN a metropolitan area network MAN a wide area network WAN and a satellite network The UE network interface 170 may be configured to support any suitable type of communication protocol

The UE I/O interface 172 may be hardware configured to perform one or more communication operations 202-234 described in process 200 in reference to FIG. 2. The UE I/O interface 172 may comprise one or more antennas as part of a transceiver, a receiver, or a transmitter for communicating using one or more wireless communication protocols or technologies. In some embodiments, the UE I/O interface 172 may be configured to communicate using, for example, 5G NR or LTE using at least some shared radio components. In other embodiments, the UE I/O interface 172 may be configured to communicate using single or shared RF bands. The RF bands may be coupled to a single antenna, or may be coupled to multiple antennas (e.g., for a MIMO configuration) to perform wireless communications. In some embodiments, the user equipment 114a may comprise capabilities for voice communication, mobile broadband services (e.g., video streaming, navigation, and the like), or other types of applications. In this regard, the UE I/O interface 172 of the user equipment 114a may communicate using machine-to-machine (M2M) communication, such as machine-type communication (MTC), or another type of M2M communication.

In some embodiments, the user equipment 114a is communicatively coupled to one or more of the base stations 160 via one or more communication links 116 (e.g., the communication link 116a and the communication link 116g representative of the communication links 116). The user equipment 114a may be a device with cellular communication capability such as a mobile phone, a hand-held device, a computer, a laptop, a tablet, a smart watch or other wearable device, or virtually any type of wireless device. In some applications, the user equipment 114 may be referred to as a UE, UE device, or terminal.

The UE processor 174 may comprise one or more processors operably coupled to and in signal communication with the UE network interface 170 the UE IO interface 172 and the UE memory 178 The UE processor 174 is any electronic circuitry including but not limited to state machines one or more CPU chips logic units cores eg a multi-core processor FPGAs ASICs or DSPs The UE processor 174 may be a programmable logic device a microcontroller a microprocessor or any suitable combination of the preceding The one or more processors in the UE processor 174 are configured to process data and may be implemented in hardware or software executed by hardware For example the UE processor 174 may be an 8-bit a 16-bit a 32-bit a 64-bit or any other suitable architecture The UE processor 174 comprises an ALU to perform arithmetic and logic operations processor registers that supply operands to the ALU and store the results of ALU operations and a control unit that fetches software instructions such as the UE instructions 180 from the UE memory 178 and executes the UE instructions 180 by directing the coordinated operations of the ALU registers and other components via the UE processing engine 176 The UE processor 174 may be configured to execute various instructions For example the UE processor 174 may be configured to execute the UE instructions 180 to implement functions or perform operations disclosed herein such as some or all of those described with respect to FIGS. 1 and 2 In some embodiments the functions described herein are implemented using logic units FPGAs ASICs DSPs or any other suitable hardware or electronic circuitry

### Radio Access Network

In one or more embodiments, the RAN 112 enables the user equipment 114 to access one or more services in the core network 110. The one or more services may be a mobile telephone service, a Short Message Service (SMS) message service, a Multimedia Message Service (MMS) message service, an Internet access, cloud computing, or other types of data services. The RAN 112 may comprise the base stations 160 in signal communication with the user equipment 114 via the one or more communication links 116. Each of the base stations 160 may service the user equipment 114. In some embodiments, while multiple base stations 160 are shown connected to multiple user equipment 114 via the communication link 116, one or more additional base stations 160 may be connected to one or more additional user equipment 114 via one or more additional communication links 116. For example, the base station 160a-110g may exchange connectivity signals with the user equipment 114a via the communication link 116a. In another example, the base station 160G may exchange connectivity signals with the user equipment 114g via the communication link 116g. In yet another example, the base stations 160 may service some user equipment 114 located within a geographic area serviced by one of the base stations 160.

In one or more embodiments referring to the base station 160a as a non-limiting example of the base station 160 the base station 160a may comprise a base station BS network interface 182 a BS IO interface 184 a BS processor 186 and a BS memory 188 The BS network interface 182 may be any suitable hardware or software eg executed by hardware to facilitate any suitable type of communication in wireless or wired connections between the core network 110 and the user equipment 114 These connections may comprise but not be limited to all or a portion of network connections coupled to additional network components 118 in the core network 110 other base stations 160 the user equipment 114 the Internet an Intranet a private network a public network a peer-to-peer network the public switched telephone network a cellular network a LAN a MAN a WAN and a satellite network The BS network interface 182 may be configured to support any suitable type of communication protocol

The BS I/O interface 184 may be hardware configured to perform one or more communication operations 202-234 described in process 200 in reference to FIG. 2. The BS I/O interface 184 may comprise one or more antennas as part of a transceiver, a receiver, or a transmitter for communicating using one or more wireless communication protocols or technologies. In some embodiments, the BS I/O interface 184 may be configured to communicate using, for example, 5G NR or LTE using at least some shared radio components. In other embodiments, the BS I/O interface 184 may be configured to communicate using single or shared RF bands. The RF bands may be coupled to a single antenna, or may be coupled to multiple antennas (e.g., for a MIMO configuration) to perform wireless communications. In some embodiments, the base station 160A may allocate resources in accordance with one or more routing and configuration operations obtained from the core network 110. In some embodiments, resources may be allocated to enable capabilities in the user equipment 114 for voice communication, mobile broadband services (e.g., video streaming, navigation, and the like), or other types of applications.

In some embodiments, the base station 160a is communicatively coupled to one or more of the user equipment 114 via the one or more communication links 116. In some applications, the base stations 160a may be referred to as BS, evolved Node B (eNodeB or eNB), a next generation Node B, gNodeB, gNB, or terminal.

The BS processor 186 may comprise one or more processors operably coupled to and in signal communication with the BS network interface 182 the BS IO interface 184 and the BS memory 188 The BS processor 186 is any electronic circuitry including but not limited to state machines one or more CPU chips logic units cores eg a multi-core processor FPGAs ASICs or DSPs The BS processor 186 may be a programmable logic device a microcontroller a microprocessor or any suitable combination of the preceding The one or more processors in the BS processor 186 are configured to process data and may be implemented in hardware or software executed by hardware For example the BS processor 186 may be an 8-bit a 16-bit a 32-bit a 64-bit or any other suitable architecture The BS processor 186 comprises an ALU to perform arithmetic and logic operations processor registers that supply operands to the ALU and store the results of ALU operations and a control unit that fetches software instructions not shown from the BS memory 188 and executes the software instructions by directing the coordinated operations of the ALU registers and other components via a processing engine not shown in the BS processor 186 The BS processor 186 may be configured to execute various instructions For example the BS processor 186 may be configured to execute the software instructions to implement functions or perform operations disclosed herein such as some or all of those described with respect to FIGS. 1 and 2 In some embodiments the functions described herein are implemented using logic units FPGAs ASICs DSPs or any other suitable hardware or electronic circuitry

### Core Network

The core network 110 may be a network configured to manage communication sessions for the user equipment 114 In one or more embodiments the core network 110 may establish connections between user equipment 114 and a particular data network 108 in accordance with one or more communication protocols In the example of FIG. 1 the core network 110 comprises one or more network components configured to perform one or more NFs In some embodiments the core network 110 enables the user equipment 114 to communicate with the server 102 or another type of device located in a particular data network 108 or in signal communication with a particular data network 108 The core network 110 may implement a communication method that does not require the establishment of a specific communication protocol connection between the user equipment 114 and one or more of the data networks 108 The core network 110 may include one or more types of network devices not shown which may perform different NFs

In some embodiments the core network 110 may include a 5G NR or an LTE access network eg an evolved packet core EPC network among others In this regard the core network 110 may comprise one or more logical networks implemented via wireless connections or wired connections Each logical network may comprise an end-to-end virtual network with dedicated power storage or computation resources Each logical network may be configured to perform a specific application comprising individual policies rules or priorities Further each logical network may be associated with a particular Quality of Service QoS class type of service or particular user associated with one or more of the user equipment 114 For example a logical network may be a Mobile Private Network MPN configured for a particular organization In this example when the user equipment 114a is configured and activated by a wireless network associated with the RAN 112 the user equipment 114a may be configured to connect to one or more particular network slices ie logical networks in the core network 110 Any logical networks or slices that may be configured for the user equipment 114a may be configured using a network component eg one of the network components 118 eg the network component 118a the network component 118b and the network component 118g representing the network component 118a-118g of FIG. 1

In one or more embodiments each of the network components 118 may comprise a component processor 192 configured to perform one or more similar operations to those described in reference to the BS processor 186 and the UE processor 174 In other embodiments each of the network components 118 may comprise a component memory 194 configured to perform one or more similar operations to those described in reference to the BS memory 188 and the UE memory 178

### Data Networks

In the example system 100 of FIG. 1, the data networks 108 may facilitate communication within the communication system 100. This disclosure contemplates that the data networks 108 may be any suitable network operable to facilitate communication between the server 102, the core network 110, the RAN 112, and the user equipment 114. The data networks 108 may include any interconnecting system capable of transmitting audio, video, signals, data, messages, or any combination of the preceding. The data networks 108 may include all or a portion of a LAN, a WAN, an overlay network, a software-defined network (SDN), a virtual private network (VPN), a packet data network (e.g., the Internet), a mobile telephone network (e.g., cellular networks, such as 4G or 5G), a Plain Old Telephone (POT) network, a wireless data network (e.g., WiFi, WiGig, WiMax, and the like), a Long Term Evolution (LTE) network, a Universal Mobile Telecommunications System (UMTS) network, a peer-to-peer (P2P) network, a Bluetooth network, a Near Field Communication network, a Zigbee network, or any other suitable network, operable to facilitate communication between the components of the communication system 100. In other embodiments, the communication system 100 may not have all of these components or may comprise other elements instead of, or in addition to, those above.

### Operation Flow

In one or more embodiments, the server 102 is configured to generate the one or more system alerts 103 based on the performance data 140 collected from the one or more communication operations 104. The system alerts 103 may be active alerts and/or cancel alerts. The active alerts may be configured to trigger adding network resources to virtual environments configured to perform the one or more communication operations 104. The cancel alerts may be configured to trigger removing network resources from virtual environments configured to perform the one or more communication operations 104. In one or more embodiments, the server 102 is configured to determine one or more metrics (e.g., conditions) to evaluate during one or more communication operations 104. The metrics may be collected after triggers from one or mor NFs are released in the communication network. The server 102 may then be configured to perform one or more of the scraping operations 138 to collect performance data 140 in accordance with the one or more conditions set up by the one or more integration parameters 136. Then, the server 102 may be configured to generate new system alerts 103 based on the performance data 140 collected and structured during the scraping operations 138. Herein, the server 102 may be configured to compare each of the new attribute parameters 148 of the new system alerts 103 to the reference parameters 146 in the reference alerts 144.

In some embodiments, the server 102 may be configured to discard specific new system alerts 103 and/or specific attribute parameters 148 based on the results of the comparisons if any of the attribute parameters 148 match a portion of any of the reference parameters 146. Further, the server 102 may be configured to discard specific new system alerts 103 and/or specific attribute parameters 148 based on the results of the comparisons if any of the attribute parameters 148 match any of the reference parameters 146. In other embodiments, the server 102 may be configured to transmit the specific new system alerts 103 and/or specific attribute parameters 148 to the network coordination system interface 150 based on the results of the comparisons if any of the attribute parameters 148 are at least partially different from a portion of any of the reference parameters 146. Further, the server 102 may be configured to transmit the specific new system alerts 103 and/or specific attribute parameters 148 to the network coordination system interface 150 based on the results of the comparisons if any of the attribute parameters 148 are different from a portion of any of the reference parameters 146. In yet other embodiments, the server 102 may be configured to discard specific new system alerts 103 and/or specific attribute parameters 148 based on the results of the comparisons if all of the attribute parameters 148 match any of the reference parameters 146. Further, the server 102 may be configured to transmit the specific new system alerts 103 and/or specific attribute parameters 148 to the network coordination system interface 150 based on the results of the comparisons if all of the attribute parameters 148 are different from a portion of any of the reference parameters 146.

### Example Process to Integrate System Alerts In Communication Network

FIG. 2 illustrate an example flowchart of the process 200 configured to integrate one or more system alerts 103 in one or more communication operations 104 in accordance with one or more embodiments Modifications additions or omissions may be made to the process 200 The process 200 may include more fewer or other operations than those shown above For example operations may be performed in parallel or in any suitable order While at times discussed as the server 102 one or more of the network components 118 one or more of the base stations 160 components of any of thereof or any suitable system or components of the communication system 100 may perform one or more operations of the process 200 For example one or more operations of the process 200 may be implemented at least in part in the form of server instructions 132 of FIG. 1 stored on non-transitory tangible machine-readable media eg server memory 130 of FIG. 1 operating as a non-transitory computer-readable medium that when run by one or more processors eg the server processor 122 of FIG. 1 may cause the one or more processors to perform operations described in operations 202-234

The process 200 starts at operation 202 where the server 102 is configured to determine multiple integration parameters 136 based at least in part upon one or more configuration commands 142 The integration parameters 136 may be instructions 132 to structure unstructured data collected from one or more communication operations 104 At operation 204 the server 102 is configured to perform multiple scraping operations 138 based on the integration parameters 136 Herein the server 102 may be configured to collect performance data 140 over a first period of time The performance data 140 may be unstructured data associated with the one or more communication operations 104 in a communication network Further the server 102 may be configured to structure the performance data 140 based at least in part upon the integration parameters 136 The server 102 may be configured to analyze a structured version of the performance data 140 At operation 206 the server 102 is configured to generate a new system alert 103a configured to trigger changes to one or more communication operations 104 in the communication network over a second period of time In some embodiments the server 102 may be configured to generate the new system alert 103a in response to analyzing the structured version of the performance data 140 The new system alert 103a may be configured to trigger at least one change to the one or more communication operations 104 in the communication network over the second period of time The new system alert 103 may comprise one or more attribute parameters 148

The process 200 continues at operation 210 where the server 102 is configured to determine whether one or more of the attribute parameters 148 are at least partially different from one or more of the reference parameters 146 If the server 102 determines that the one or more attribute parameters 148 are not at least partially different from the one or more reference parameters 146 ie NO the process 200 proceeds to operation 222 If the server 102 determines that the one or more attribute parameters 148 are at least partially different from the one or more reference parameters 146 ie YES the process 200 proceeds to operation 232

The process 200 may conclude at operations 222 and 224 where the server 102 is configured to perform one or more operations in response to determining that none of the attribute parameters 148 of the new system alert 103a match any of the reference parameters 146 in the reference alerts 144 At operation 222 the server 102 is configured to validate the system alert 103a as a unique system alert 103 At operation 224 the server 102 is configured to transmit the new system alert 103a to the network coordination system interfaces 150 The server 102 may be configured to cause the network coordination system interfaces 150 to publish the unique system alert 103 via the network coordination system interfaces 150 configured to modify the one or more communication operations 104 in the communication network over the second period of time As described above the network coordination system interface 150 is configured to cause one or more changes in the one or more communication operations 104 in the communication network over the second period of time Herein the process 200 may comprise saving the unique system alert 103 as a reference alert 144a

The process 200 may conclude at operations 232 and 234 where the server 102 is configured to perform one or more operations in response to determining that a new attribute parameter 148b of the new system alert 103a matches a reference parameter 146a in a reference alert 144b At operation 232 the server 102 is configured to determine that the new system alert 103a is a repeated alert At operation 234 the server 102 is configured to discard the system alert 103a

In one or more embodiments the one or more reference parameters 146 and the one or more attribute parameters 148 may comprise Cluster identifiers IDs configured to reference one or more clusters of virtual containers in one or more containerized environments function information associated with one or more NFs NF names in information elements tracking NFName site IDs configured to reference one or more communication sites one or more alert names referencing specific name alerts and severity of the one or more system alerts 103 among others

As a first non-limiting example the server 102 may be configured to track a number of network resources associated with evaluating one or more communication operations 104 In one or more embodiments the server 102 may be configured to trigger changes that start new system alerts 103 In some embodiments the server 102 may be configured to trigger changes that cancel new system alerts 103

### Scope Of The Disclosure

While several embodiments have been provided in the present disclosure it should be understood that the disclosed systems and methods might be embodied in many other specific forms without departing from the spirit or scope of the present disclosure The present examples are to be considered as illustrative and not restrictive and the intention is not to be limited to the details given herein For example the various elements or components may be combined or integrated with another system or certain features may be omitted or not implemented

In addition techniques systems subsystems and methods described and illustrated in the various embodiments as discrete or separate may be combined or integrated with other systems modules techniques or methods without departing from the scope of the present disclosure Other items shown or discussed as coupled or directly coupled or communicating with each other may be indirectly coupled or communicating through some interface device or intermediate component whether electrically mechanically or otherwise Other examples of changes substitutions and alterations are ascertainable by one skilled in the art and could be made without departing from the spirit and scope disclosed herein

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. An apparatus, comprising:
a memory operable to store:
one or more configuration commands configured to control one or more communication operations in a communication network; and
a plurality of reference alerts configured to trigger one or more changes to the one or more communication operations, each reference alert comprising at least one reference parameter configured to define at least one change to the one or more communication operations; and
a processor communicatively coupled to the memory and configured to:
determine a first plurality of integration parameters based at least in part upon the one or more configuration commands, the first plurality of integration parameters being instructions to structure unstructured data collected from the one or more communication operations;
collect first performance data over a first period of time, the first performance data being unstructured data associated with the one or more communication operations in the communication network;
structure the first performance data based at least in part upon the first plurality of integration parameters;
analyze a structured version of the first performance data;
in response to analyzing the structured version of the first performance data, generate a first system alert, wherein:
the first system alert is configured to trigger a first change to the one or more communication operations in the communication network over a second period of time; and
the first system alert comprises a first attribute parameter;
determine whether the first attribute parameter is at least partially different from the at least one reference parameter in the plurality of reference alerts; and
in response to determining that the first attribute parameter is at least partially different from the at least one reference parameter in the plurality of reference alerts, transmit the first system alert to a network coordination system interface configured to implement the first change in the one or more communication operations in the communication network over the second period of time.

2. The apparatus of claim 1, wherein the processor is further configured to:
determine a second plurality of integration parameters based at least in part upon the one or more configuration commands;
collect second performance data over a third period of time;
structure the second performance data based at least in part upon the second plurality of integration parameters;
in response to structuring the second performance data, generate a second system alert, wherein:
the second system alert is configured to trigger a second change to the one or more communication operations in the communication network over a fourth period of time; and
the second system alert comprises a plurality of attribute parameters;
determine whether the at least one reference parameter in the plurality of reference alerts is at least partially different from the plurality of attribute parameters; and
in response to determining that the at least one reference parameter in the plurality of reference alerts is different from the plurality of attribute parameters, transmit the second system alert to the network coordination system interface configured to implement the second change in the one or more communication operations in the communication network over the fourth period of time.

3. The apparatus of claim 1, wherein the processor is further configured to:
determine a second plurality of integration parameters based at least in part upon the one or more configuration commands;
collect second performance data over a third period of time;
structure the second performance data based at least in part upon the second plurality of integration parameters;
in response to structuring the second performance data, generate a second system alert, wherein:
the second system alert is configured to trigger a second change to the one or more communication operations in the communication network over a fourth period of time; and
the second system alert comprises a second attribute parameter;
determine whether the second attribute parameter at least partially matches the at least one reference parameter in the plurality of reference alerts;
in response to determining that the second attribute parameter matches the at least one reference parameter in the plurality of reference alerts, determine that the second system alert is a repeated alert; and
discard the second system alert.

4. The apparatus of claim 1, wherein:
the first system alert is an active alert configured to trigger adding network resources to virtual environments configured to perform the one or more communication operations.

5. The apparatus of claim 1, wherein:
the first system alert is a cancel alert configured to trigger removing network resurces from virtual environments configured to perform the one or more communication operations.

6. The apparatus of claim 1, wherein the plurality of reference alerts is updated periodically over time.

7. The apparatus of claim 1, wherein the plurality of reference alerts is updated dynamically over time.

8. A method, comprising:
determining a first plurality of integration parameters based at least in part upon one or more configuration commands, the first plurality of integration parameters being instructions to structure unstructured data collected from one or more communication operations;
collecting first performance data over a first period of time, the first performance data being unstructured data associated with the one or more communication operations in a communication network;
structuring the first performance data based at least in part upon the first plurality of integration parameters;
analyzing a structured version of the first performance data;
in response to analyzing the structured version of the first performance data, generating a first system alert, wherein:
the first system alert is configured to trigger a first change to the one or more communication operations in the communication network over a second period of time; and
the first system alert comprises a first attribute parameter;
determining whether the first attribute parameter is at least partially different from at least one reference parameter in a plurality of reference alerts; and
in response to determining that the first attribute parameter is at least partially different from the at least one reference parameter in the plurality of reference alerts, transmitting the first system alert to a network coordination system interface configured to implement the first change in the one or more communication operations in the communication network over the second period of time.

9. The method of claim 8, further comprising:
determining a second plurality of integration parameters based at least in part upon the one or more configuration commands;
collecting second performance data over a third period of time;
structuring the second performance data based at least in part upon the second plurality of integration parameters;
in response to structuring the second performance data, generating a second system alert, wherein:
the second system alert is configured to trigger a second change to the one or more communication operations in the communication network over a fourth period of time; and
the second system alert comprises a plurality of attribute parameters;
determining whether the at least one reference parameter in the plurality of reference alerts is at least partially different from the plurality of attribute parameters; and
in response to determining that the at least one reference parameter in the plurality of reference alerts is different from the plurality of attribute parameters, transmitting the second system alert to the network coordination system interface configured to implement the second change in the one or more communication operations in the communication network over the fourth period of time.

10. The method of claim 8, further comprising:
determining a second plurality of integration parameters based at least in part upon the one or more configuration commands;
collecting second performance data over a third period of time;
structuring the second performance data based at least in part upon the second plurality of integration parameters;
in response to structuring the second performance data, generating a second system alert, wherein:
the second system alert is configured to trigger a second change to the one or more communication operations in the communication network over a fourth period of time; and
the second system alert comprises a second attribute parameter;
determining whether the second attribute parameter at least partially matches the at least one reference parameter in the plurality of reference alerts;
in response to determining that the second attribute parameter matches the at least one reference parameter in the plurality of reference alerts, determining that the second system alert is a repeated alert; and
discarding the second system alert.

11. The method of claim 8, wherein:
the first system alert is an active alert configured to trigger adding network resources to virtual environments configured to perform the one or more communication operations.

12. The method of claim 8, wherein:
first system alert is a cancel alert configured to trigger removing network resurces from virtual environments configured to perform the one or more communication operations.

13. The method of claim 8, wherein the plurality of reference alerts is updated periodically over time.

14. The method of claim 8, wherein the plurality of reference alerts is updated dynamically over time.

15. A non-transitory computer-readable medium storing instructions that when executed by a processor cause the processor to:
determine a first plurality of integration parameters based at least in part upon one or more configuration commands, the first plurality of integration parameters being instructions to structure unstructured data collected from one or more communication operations;
collect first performance data over a first period of time, the first performance data being unstructured data associated with the one or more communication operations in a communication network;
structure the first performance data based at least in part upon the first plurality of integration parameters;
analyze a structured version of the first performance data;
in response to analyzing the structured version of the first performance data, generate a first system alert, wherein:
the first system alert is configured to trigger a first change to the one or more communication operations in the communication network over a second period of time; and
the first system alert comprises a first attribute parameter;
determine whether the first attribute parameter is at least partially different from at least one reference parameter in a plurality of reference alerts; and
in response to determining that the first attribute parameter is at least partially different from the at least one reference parameter in the plurality of reference alerts, transmit the first system alert to a network coordination system interface configured to implement the first change in the one or more communication operations in the communication network over the second period of time.

16. The non-transitory computer-readable medium of claim 15, wherein, when executed by the processor, the instructions further cause the processor to:
determine a second plurality of integration parameters based at least in part upon the one or more configuration commands;
collect second performance data over a third period of time;
structure the second performance data based at least in part upon the second plurality of integration parameters;
in response to structuring the second performance data, generate a second system alert, wherein:
the second system alert is configured to trigger a second change to the one or more communication operations in the communication network over a fourth period of time; and
the second system alert comprises a plurality of attribute parameters;
determine whether the at least one reference parameter in the plurality of reference alerts is at least partially different from the plurality of attribute parameters; and
in response to determining that the at least one reference parameter in the plurality of reference alerts is different from the plurality of attribute parameters, transmit the second system alert to the network coordination system interface configured to implement the second change in the one or more communication operations in the communication network over the fourth period of time.

17. The non-transitory computer-readable medium of claim 15, wherein, when executed by the processor, the instructions further cause the processor to:
determine a second plurality of integration parameters based at least in part upon the one or more configuration commands;
collect second performance data over a third period of time;
structure the second performance data based at least in part upon the second plurality of integration parameters;
in response to structuring the second performance data, generate a second system alert, wherein:
the second system alert is configured to trigger a second change to the one or more communication operations in the communication network over a fourth period of time; and
the second system alert comprises a second attribute parameter;
determine whether the second attribute parameter at least partially matches the at least one reference parameter in the plurality of reference alerts;
in response to determining that the second attribute parameter matches the at least one reference parameter in the plurality of reference alerts, determine that the second system alert is a repeated alert; and
discard the second system alert.

18. The non-transitory computer-readable medium of claim 15, wherein:
the first system alert is an active alert configured to trigger adding network resources to virtual environments configured to perform the one or more communication operations.

19. The non-transitory computer-readable medium of claim 15, wherein:
first system alert is a cancel alert configured to trigger removing network resurces from virtual environments configured to perform the one or more communication operations.

20. The non-transitory computer-readable medium of claim 15, wherein the plurality of reference alerts is updated periodically over time.
